(19) United States
(12) Patent Application Publication
(10) Pub. No.: US 2021/0348840 A1
(43) Pub. Date: Nov. 11, 2021

(54) METHOD FOR OPERATING A RELIQUEFACTION SYSTEM

(71) Applicants: L'Air Liquide, Société Anonyme pour l'Etude et l'Exploitation des Procédés Georges Claude, Paris (FR); Air Liquide Advanced Technologies U.S. LLC, Houston, TX (US); Air Liquide Large Industries U.S. LP, Houston, TX (US)

(72) Inventors: Pierre-Philippe GUERIF, Houston, TX (US); Alain GUILLARD, Houston, TX (US); Gilles FLAVIEN, Grenoble (FR); Vincent FOLLACA, Houston, TX (US); Paul KONG, Houston, TX (US)

(21) Appl. No.: 17/315,044

(22) Filed: May 7, 2021

Related U.S. Application Data
(60) Provisional application No. 63/021,880, filed on May 8, 2020.
(60) Provisional application No. 63/021,889, filed on May 8, 2020.

(51) Int. Cl. F25J 1/00; F25J 1/02

(52) U.S. Cl. CPC F25J 1/0045; F25J 1/0057; F25J 1/0235; F25J 2230/42; F25J 2260/44; F25J 2230/24; F25J 1/0236

(57) ABSTRACT

A method for increasing the reliability and availability of a cryogenic fluid reliquefaction system is provided. It may comprise at least N sub-coolers comprising a motor and a compressor and at least one variable speed. It may comprise N−1 variable speed systems to be shared between the motors and compressors if N equals 2, or N−2 variable speed systems to be shared between the motors and compressors if N is greater than 2. It may comprise two different liquid cryogenic fluid users are provided liquid cryogenic fluid, utilizing two different main cryogenic tanks, with a common sub-cooler and recirculation loop, wherein the pressure in the two different main cryogenic tanks are controlled with pressure controllers acting on two different subcooled liquid cryogenic fluid valves. And or, it may comprise at least one liquid cryogenic fluid user is provided refrigeration from two or more sub-cooling systems in a lead-lag arrangement.

### CROSS REFERENCE TO RELATED APPLICATIONS

This application claims the benefit of priority under 35 U.S.C. § 119 (a) and (b) to U.S. Provisional Patent Application Nos. 63/021,868, 63/021,880, and 63/021,889, all filed May 8, 2020, the entire contents of which are incorporated herein by reference.

### BACKGROUND

In some particular applications, a cryogenic liquid stream such as liquid nitrogen may be used for cooling purpose. In this case, the liquid nitrogen will usually, at least partially vaporize, and there will be a need to recondense this nitrogen vapor to avoid losses of nitrogen product and cold energy (refrigeration). A typical method used to recondense such a stream is to cool the gas and extract some enthalpy until the liquefaction is complete. The enthalpy extraction is typically performed via indirect thermal exchange with another fluid which will typically undergo some various steps of compression, cooling and pressure letdown in valves or/and turbines.

A typical alternate solution is to mix the gaseous stream with a subcooled liquid so that the direct thermal exchange between the gas and subcooled liquid will condense the gaseous stream. This mixing can typically be implemented in the vapor phase of a tank.

### SUMMARY

A method for increasing the reliability and availability of a cryogenic fluid reliquefaction system is provided. The reliquefaction system may comprise at least N sub-coolers, the N sub-coolers comprising a motor and a compressor with a design capacity, and at least one variable speed system to control the speed of at least one motor. The reliquefaction system comprising N−1 variable speed systems to be shared between the motors and compressors if N equals 2, or N−2 variable speed systems to be shared between the motors and compressors if N is greater than 2. The method comprising connecting a reliquefaction system to a liquid cryogenic fluid user which is then supplied a liquid cryogenic fluid, vaporizing the liquid cryogenic fluid within the liquid cryogenic fluid user, and sending the vaporized cryogenic fluid back to the main cryogenic tank. Wherein, when a first motor and compressor with a variable speed system is at or near design capacity, the first motor is disengaged from the variable speed system and connected to an existing power grid, thus freeing the variable speed system, the variable speed system is engaged to a second motor and compressor, the second motor and compressor is then started.

The reliquefaction system may comprise two different liquid cryogenic fluid users are provided liquid cryogenic fluid, utilizing two different main cryogenic tanks, with a common sub-cooler and recirculation loop, wherein the pressure in the two different main cryogenic tanks are controlled with pressure controllers acting on two different subcooled liquid cryogenic fluid valves. And or, the reliquefaction system may comprise at least one liquid cryogenic fluid user is provided refrigeration from two or more sub-cooling systems in a lead-lag arrangement, wherein the pressure in the main cryogenic tank is controlled with a pressure controller acting on outlet valves for each sub-cooler outlet valve.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of the basic overall system, accordance with one embodiment of the present invention.

FIG. 2 is a schematic representation showing details of the liquid cryogenic users and main cryogenic tanks of a two-train system, accordance with one embodiment of the present invention.

FIG. 3 is a schematic representation showing details of the sub-cooling systems of a two-train system, accordance with one embodiment of the present invention.

FIG. 4 is a schematic representation of a Turbo Brayton system, accordance with one embodiment of the present invention.

### ELEMENT NUMBERS

102=main cryogenic tank
103=liquid cryogenic fluid stream
104=vaporized cryogenic fluid stream
105=vent valve
106=sub-cooler
107=warm recirculation stream
108=subcooled recirculation stream
109=recirculation control valve
110=recirculation pump
111=liquid buffer tank
112=buffer tank transfer stream
113=buffer tank transfer control valve
114=liquid cryogenic fluid (in main cryogenic tank)
115=cryogenic fluid vapor (in main cryogenic tank)
116=liquid cryogenic fluid user
117=external liquid cryogenic fluid source
118=sub-cooler bypass line
119=first pressure transmitter (in main cryogenic tank)
120=first peripheral interface controller
122=second pressure transmitter (in subcooler bypass line)
123=second peripheral interface controller
124=third peripheral interface controller
125=bypass control valve
102A=first cryogenic tank
102B=second cryogenic tank
103A=first liquid cryogenic fluid stream
103B=second liquid cryogenic fluid stream
104A=first vaporized cryogenic fluid stream
104B=second vaporized cryogenic fluid stream
105A=first vent valve
105B=second vent valve
106A=first sub-cooler
106B=second sub-cooler
107=warm recirculation stream
107A=first warm recirculation stream portion
107B=second warm recirculation stream portion
108=subcooled recirculation stream
108A=first subcooled recirculation stream portion
108B=second subcooled recirculation stream portion
109A=first recirculation control valve
109B=second recirculation control valve
110A=first recirculation pump
110B=second recirculation pump
110C=transfer pump
114A=liquid cryogenic fluid (in first cryogenic tank)
114B=liquid cryogenic fluid (in second cryogenic tank)
115A=cryogenic fluid vapor (in second cryogenic tank)
115B=cryogenic fluid vapor (in second cryogenic tank)
116A=first liquid cryogenic fluid user
116B=second liquid cryogenic fluid user
119A=first pressure transmitter (in main cryogenic tank)
119B=second pressure transmitter (in main cryogenic tank)
120=first peripheral interface controller
122=second pressure transmitter (in subcooler bypass line)
123=second peripheral interface controller
124=third peripheral interface controller
125=bypass control valve
126A=first pressure building coil
126B=second pressure building coil
127A=first pressure controller
127B=second pressure controller
128=return conduit
129=warm cryogenic liquid return stream
130=warm recirculation feed stream
130A=first portion of warm recirculation feed stream
130B=second portion of warm recirculation feed stream
131=warm cryogenic liquid supply line
132=cooling water supply line
133=cooling water return line DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

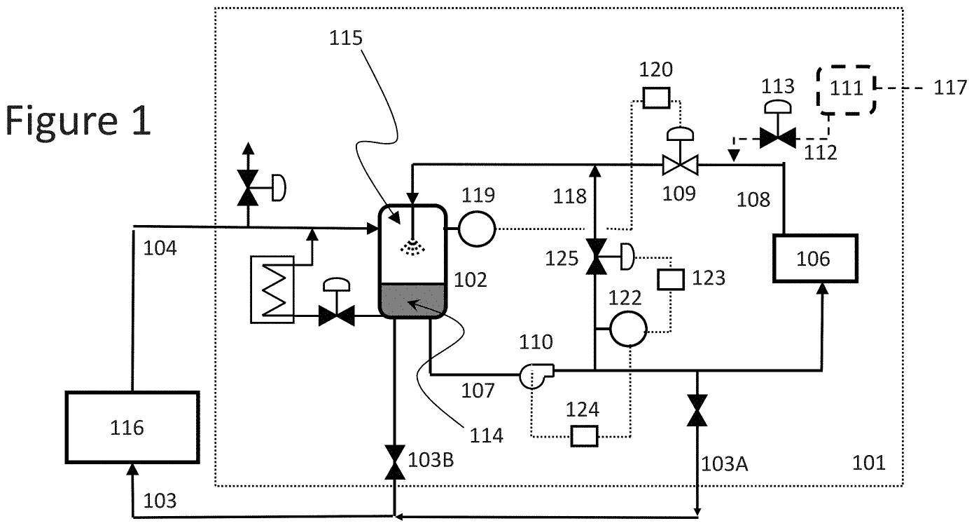

In the interest of simplicity, the following is a description of the basic operation of a simplified system with one cryogenic tank and one sub-cooler as illustrated in FIG. 1. The element numbers are generic, but one of ordinary skill in the art would recognize that the description applies equally to the first train (A) or the second train (B). Details of the operation involving two cryogenic tanks and/or two sub-coolers are given below.

The system below describes the use of liquid nitrogen, but one skilled in the art will recognize that any suitable cryogenic fluid may be used with the same concept (oxygen, methane, etc. . . . ) depending on the temperature level required for cooling the targeted system.

Liquid nitrogen 114 is stored at saturated conditions (pressure P1) in main cryogenic Tank 102. Nitrogen vapor 115 will occupy the headspace of main cryogenic tank 102. During normal operations, a portion of liquid nitrogen 114 is extracted from main cryogenic tank 102 and sent to a liquid nitrogen user 116. Liquid nitrogen user 116 will utilize liquid nitrogen stream 103 for internal refrigeration purposes. Liquid nitrogen stream 103 will thus be vaporized and vaporized nitrogen stream 104 will be recirculated to main cryogenic Tank 102.

Simultaneously, a portion of liquid nitrogen 114 is extracted from main cryogenic tank 102 as warm recirculation stream 107 and sent to recirculation pump 110. The pressurized liquid nitrogen then enters sub-cooler 106. Sub-cooler 106 will cool the liquid nitrogen by at least several degrees Celsius. Subcooled recirculation stream 108 is then returned to main cryogenic tank 102 where it is introduced into vapor phase 115 as a spray. When contacted with the subcooled liquid, vaporized nitrogen stream 104, returning from liquid nitrogen user 116, is cooled and condenses back to saturated liquid 114.

Main cryogenic tank 102 may include first pressure transmitter 119. First pressure transmitter 119 may interface with one or more peripheral interface controller (PIC). First PIC 120 is functionally connected to both first pressure transmitter 119 and recirculation control valve 109. Sub-cooler bypass line 118, is fluidically connected to warm recirculation stream 107 and subcooled recirculation stream 108, thereby allowing at least a portion of the pressurized recirculation stream exiting recirculation pump 110 to bypass sub-cooler 106. Sub-cooler bypass line 118 may include second pressure transmitter 122. Second pressure transmitter 122 may interface with one or more PICs. Second PIC 123 is functionally connected to both second pressure transmitter 122 and bypass control valve 125. Third PIC 124 is functionally connected to both second pressure transmitter 122 and recirculation pump 110.

The pressure within main cryogenic tank 102 is primarily controlled by recirculation control valve 109 on the subcooled recirculation stream 108 exiting sub-cooler 106

The reliquefaction system also includes a liquid buffer tank 111, a buffer tank transfer stream 112, and a buffer tank transfer control valve 113. Liquid buffer tank 111 may be refilled as needed from an external liquid nitrogen source 117, such as a liquid nitrogen truck trailer (not shown).

In the following embodiments, for ease of explanation and to avoid unnecessary confusion, a system with two trains (Train A and Train B) is illustrated. One of ordinary skill in the art will recognize that the same methods described are easily applicable to 3 or more trains if such design considerations are desired.

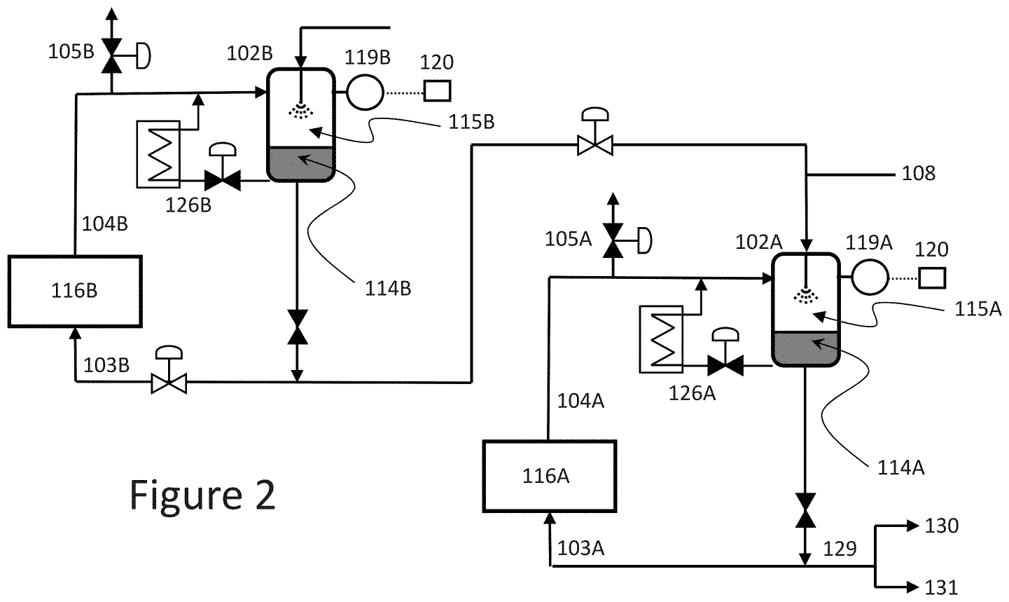

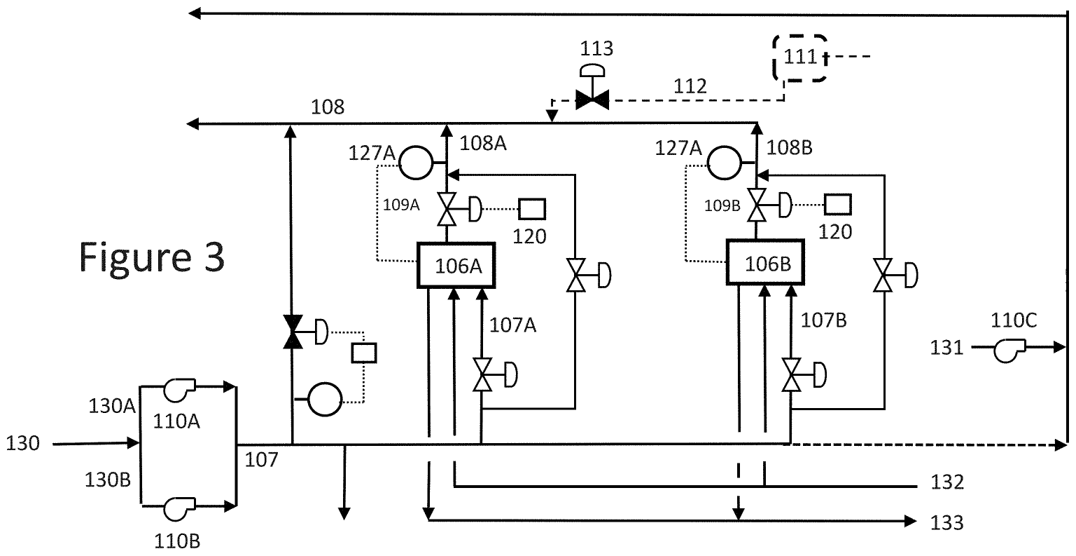

One embodiment of the present invention is schematically illustrated in FIGS. 2 and 3. A reliquefaction system includes first cryogenic tank 102A, second cryogenic tank 102B, first liquid nitrogen stream 103A, second liquid nitrogen stream 103B, first vaporized nitrogen stream 104A, second vaporized nitrogen stream 104B, first vent valve 105A fluidically attached to first vaporized nitrogen stream 104A, and second vent valve 105B fluidically attached to second vaporized nitrogen stream 104B.

The reliquefaction system also includes first sub-cooler 106A, second sub-cooler 106B, warm recirculation stream 107, first warm recirculation stream portion 107A, second warm recirculation stream portion 107B, subcooled recirculation stream 108, first subcooled recirculation stream portion 108A, second subcooled recirculation stream portion 108B, first recirculation control valve 109A, second recirculation control valve 109B, first recirculation pump 110A, second recirculation pump 110B, and third recirculation pump 110C.

First sub-cooler 106A and second sub-cooler 106B, as well as any potential additional sub-coolers, may be cooled by cooling water supply line 132 and cooling water return line 133.

In one embodiment of the present invention, liquid cryogen is subcooled using 2 or more sub-cooling systems in parallel. These 2 or more subcooling systems can be of similar or different cooling capacity. The interest of using subcooling systems in parallel is to increase the overall availability of the plant as well as to increase the cooling capacity of the reliquefaction plant.

The pressure in first cryogenic tank 102B is maintained between 2 desired maximum values by means of both a first pressure building coil 126A if pressure reaches a predetermined minimum threshold, and first vent valve 105A if pressure reaches a predetermined maximum threshold.

First and second pressure building coils 126A/B are well known in the art. They are typically ambient temperature vaporizers that use heat from the environment to vaporize a small amount of the cryogenic liquid 114A in the tank. This small amount of vaporized liquid is then readmitted into the tank in order to maintain or increase the internal pressure as required.

The pressure in first cryogenic tank 102B is controlled to a constant value which is set to be between the predetermined minimum and predetermined maximum pressure values defined above. The control of this pressure is ensured by a pressure controller 127A/B acting on sub-cooler outlet valves 109A/B. A lead-lag control scheme is implemented so that the next sub-cooler cooling capacity only increases once the outlet valve of the previous one is fully open or nearly fully open.

As used herein, the term “at or near design capacity” is defined as meaning within 80% of the design capacity, preferably within 90% of the design capacity, and more preferably within 95% of the design capacity.

As used herein, the term “lead-lag system” is defined as one wherein when the system demand exceeds the design capacity of a single unit, and when the “lead” device is at or near its design capacity, a “lag” device is activated and utilized to meet the system demand. Such “lead-lag” systems are well known in the art.

As used here, the term “fully open or nearly fully open”, in reference to a valve, is defined as meaning within 80% of the fully open position, preferably within 90% of the fully open position, and more preferably within 95% of the fully open position.

Each sub-cooler controls the temperature of the sub-cooled liquid cryogen at their respective outlet. The temperature set point can be the same for each sub-cooler and should be a few Celsius below the Saturation Temperature in the associated cryogenic tank 102A/B (typically 10 Celsius less).

In order to balance the flow correctly through each sub-cooler, the following must be taken into consideration:
the cooling duty of that sub-cooler (typically the speed of the associated turbo machines)
the difference between the temperature downstream the sub-cooler and the temperature set point.

A sub-cooler that is being used at full capacity or almost full capacity, with an outlet temperature higher than the set point while extra capacity is still available on other sub-cooler(s), will receive too much flow compared to the others. A specific controller acting on the maximum or close to maximum opening of the valve downstream this sub-cooler will allow reducing the flow on this sub-cooler in this specific condition.

In another embodiment of the present invention, during nominal operation conditions, the liquid nitrogen from first cryogenic tank 102A is sub-cooled in one or more sub-cooling units set in parallel. The sub-cooled nitrogen is then sprayed in first cryogenic tank 102A and mixed with superheated vapors 104A from the first liquid cryogenic fluid user 116A.

Second cryogenic tank 102B is maintained and operated at a higher pressure than first cryogenic tank 102A. First liquid cryogenic fluid stream 103A from first cryogenic tank 102A is colder than second liquid cryogenic fluid stream 103B and is pumped up to second cryogenic tank 102B pressure and mixed with superheated vapors 104B from second liquid cryogenic fluid user 116B.

Liquid cryogenic fluid 114B from second cryogenic tank 102B is transferred back to first cryogenic tank 102A through return conduit 128 in order to maintain the level of liquid cryogenic fluid 114A in first cryogenic tank 102A. If sub-cooler 106A/B are turned down or stopped, the system can still operate for both levels of temperature. Liquid cryogenic fluid stream 103A/B that is being vaporized by liquid cryogenic fluid user 116A/B is then vented through vent valve 105A/B.

If the inventory of liquid cryogenic fluid 114A is approaching a lower limit in first cryogenic tank 102A, liquid cryogenic fluid 114B from second cryogenic tank 102B can be used to supply first cryogenic tank 102A. If the inventory of liquid cryogenic fluid 114B is approaching a lower limit in second cryogenic tank 102B, liquid cryogenic fluid 114A from first cryogenic tank 102A can be used to supply second cryogenic tank 102B through warm cryogenic liquid supply line 131 using transfer pump 110C.

Additional sub-coolers 106 can be added to the previously described system. Each sub-cooler 106A/B can be configured to provide the same cooling temperature if desired. The increased number of sub-cooling units helps the overall capacity and availability of the system:

In one embodiment, each sub-cooler 106A/B may be disconnected from first cryogenic tank 102A, and only be connected to second cryogenic tank 102B. This configuration allows a higher efficiency of the overall cooling system when one of the cryogenic tanks 102A/B is operated at a higher temperature than the other one.

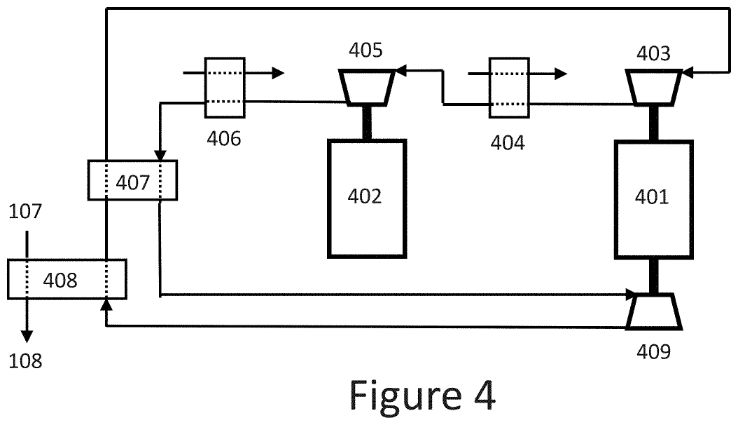

Turning to FIG. 4, a typical Turbo-Brayton cycle is presented. The Turbo-Brayton is a low-temperature refrigerating device, typically between −100° C. and −273° C., and therefore cryogenic). This is a closed working circuit containing a working fluid cycle which a cryogenic temperature. The cooled working fluid undergoes heat exchange with warm recirculation stream 107 to extract heat from it by means of sub-cooler heat exchanger 408.

The working circuit comprises, arranged in series: first compression stage 403, second compression stage 405 (preferably isentropic or substantially isentropic), intercooler 404, aftercooler 406, and recuperative heat exchanger 407 for cooling the fluid (preferably isobaric or substantially isobaric), a turboexpander 409 for expansion of the fluid (preferably isentropic or substantially isentropic) and recuperative heat exchanger 407, and sub-cooler heat exchanger 408 for heating the fluid (preferably isobaric or substantially isobaric).

The typical Turbo-Brayton system comprises first motor 401, and second motor 402, preferably electric, for driving first compression stage 403 and second compression stage 405 respectively. Turboexpander 409 typically comprises a centripetal type turbine driving first motor 401. More precisely turboexpander 409 aids first motor 401 in driving the first compression stage.

Thus, the device uses two motors 401/402 and second motor 402 drives, only at one of its ends, second compression stage 405. Second compression stage 405 is located downstream of first compression stage 403 (downstream refers to the direction of circulation of the working fluid in the circuit 10).

This novel architecture makes it possible to distribute the overall increase in enthalpy, Δhs, over the two compression stages and consequently makes it possible to reduce the increase in enthalpy, Δhs, of one stage and increase the specific speed of the compression stages to get closer to the optimum specific speed for each compressor.

This overall increase in enthalpy, Δhs, is distributed between the two compression stages 403/405, again making it possible to increase the specific speed of the compression stages and approach or reach the optimum specific speed. Owing to this novel architecture, the two compression stages 403/405 can operate close to or at the optimum specific speed (and not only the first stage as was the case in the prior art).

In one operating mode, the two motors 401/402 are identical, the speeds of the two motors are identical and the specific speeds of the two compressors 4031405 are identical and optimum.

In another operating mode, the two compression stages 403/405 may be controlled by variable speed motors, and operate at different speeds to operate close to or at the optimum specific speed also in the case when the mechanical power and/or the rotary speed of the two motors 401/402 are different. The compression ratios of the two compression stages 403/405 may be selected so that the specific speed of the two compression stages is as close as possible to the optimum value.

Turning back to FIGS. 2 and 3, in another embodiment of the present invention, a liquid cryogen may be sub-cooled using two or more sub-cooling systems in parallel. These two or more sub-cooling systems can be of similar or different cooling capacity. The interest of using sub-cooling systems in parallel is to increase the overall availability of the plant as well as to increase the cooling capacity of the plant.

As discussed above with respect to a Turbo-Brayton system, some sub-cooler systems require a variable speed system during the start-up and/or to control the operation of their turbomachinery in an efficient way between reduced and high load. In case of a system with multiple sub-coolers of the same size, one can envision sharing variable speed systems between those different sub-coolers. When one sub-cooler is started, then a variable speed system will be used for controlling its ramp up. When a load close to the maximum cooling power of the sub-cooler is reached and some extra cooling is needed, then the variable speed system linked to the aforementioned sub-cooler will be switched to another sub-cooler to be started and the sub-cooler close to the maximum cooling power will be linked to the electrical network before the variable speed system switching. During this transition, the sub-coolers' system will not be able to follow the variation of the load so some liquid nitrogen from the first cryogenic tank 102B will be used to compensate this lack of refrigeration supply from the sub-coolers.

In case two sub-coolers are installed, then one variable speed system can be shared between each turbomachine of each sub-cooler. In the case where N equals 2, only one variable speed system (i.e. N−1) is present. In case where N is greater than 2, one or more variable speed system (i.e. N−2) is present. The variable speed systems may be shared between the N sub-cooler's turboexpanders.

As a non-limiting example where N=3, there will be 1 variable speed system and 2 constant speed systems present. In such a situation, when turboexpander 1 (with the variable speed system) is at or near design capacity, turboexpander 2 (next in the series) will be started and ramped up. Once at speed, the variable speed system is switched from turboexpander 1 to turboexpander 2, and turboexpander 1 now is operated at constant speed. As used here, the term “at or near design capacity” is defined as meaning within 80% of the design capacity, preferably within 90% of the design capacity, and more preferably within 95% of the design capacity.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for increasing the reliability and availability of a cryogenic fluid reliquefaction system, comprising at least N sub-coolers, the N sub-coolers comprising a motor and a compressor with a design capacity, and at least one variable speed system to control the speed of at least one motor, and
N−1 variable speed systems to be shared between the motors and compressors if N equals 2, or
N−2 variable speed systems to be shared between the motors and compressors if N is greater than 2,
the method comprising:
connecting a reliquefaction system to a liquid cryogenic fluid user which is then supplied a liquid cryogenic fluid,
vaporizing the liquid cryogenic fluid within the liquid cryogenic fluid user,
sending the vaporized cryogenic fluid back to the main cryogenic tank,
wherein
when a first motor and compressor with a variable speed system is at or near design capacity,
the first motor is disengaged from the variable speed system and connected to an existing power grid, thus freeing the variable speed system,
the variable speed system is engaged to a second motor and compressor,
the second motor and compressor is then started.

2. The method of claim 1, wherein the reliquefaction system comprises at least a main cryogenic tank, a sub-cooler and a recirculation pump.

3. The method of claim 1, wherein the cryogenic fluid is selected from the group consisting of nitrogen, helium, argon, oxygen, krypton, xenon, carbon dioxide, methane, ethane, propane, hydrogen, and combinations thereof.

4. A method for increasing the reliability and availability of a cryogenic fluid reliquefaction system, comprising:
connecting a reliquefaction system to at least one liquid cryogenic fluid user which is then supplied a liquid cryogenic fluid,
vaporizing the liquid cryogenic fluid within the liquid cryogenic fluid user,
sending the vaporized cryogenic fluid back to the main cryogenic tank,
wherein
two different liquid cryogenic fluid users are provided liquid cryogenic fluid, utilizing two different main cryogenic tanks, with a common sub-cooler and recirculation loop, wherein the pressure in the two different main cryogenic tanks are controlled with pressure controllers acting on two different subcooled liquid cryogenic fluid valves, and/or
at least one liquid cryogenic fluid user is provided refrigeration from two or more sub-cooling systems in a lead-lag arrangement, wherein the pressure in the main cryogenic tank is controlled with a pressure controller acting on outlet valves for each sub-cooler outlet valve.

5. The method of claim 4, wherein the reliquefaction system comprises at least a main cryogenic tank, at least one sub-cooler and at least one recirculation pump.

6. The method of claim 4, wherein the cryogenic fluid is selected from the group consisting of nitrogen, helium, argon, oxygen, krypton, xenon, carbon dioxide, methane, ethane, propane, hydrogen, and combinations thereof.

7. The method of claim 4, wherein if two or more reliquefaction systems are used, they are operated at the same temperature level.

8. The method of claim 4, wherein if two or more reliquefaction systems are used, they are operated at different temperature levels.

9. The method of claim 4, wherein the sub-cooling systems comprise a downstream fluid temperature, and a fluid temperature setpoint, and wherein the flowrate is balanced between the sub-coolers by using the cooling duty of the sub-coolers, and the difference between the downstream fluid temperature of the sub-cooler and the fluid temperature set point.
